(19) United States
(12) Patent Application Publication
(10) Pub. No.: US 2019/0300291 A1
(43) Pub. Date: Oct. 3, 2019

(54) TRAILERS, SYSTEMS AND METHODS FOR TRANSFERRING MATERIAL

(71) Applicant: Dan Jones, Inc., Vancouver (CA)

(72) Inventor: Randall T. JONES, Washougal, WA (US)

(21) Appl. No.: 16/151,885

(22) Filed: Oct. 4, 2018

Related U.S. Application Data
(63) Continuation of application No. 15/262,876, filed on Sep. 12, 2016, now abandoned.
Application No. 15/262,876 is a continuation of application No. 13/355,896, filed on Jan. 23, 2012, now abandoned.
Application No. 13/355,896 is a continuation of application No. 12/217,695, filed on Jul. 8, 2008, now abandoned.

(51) Int. Cl. B65G 41/00

(52) U.S. Cl. CPC B65G 41/008; B65G 41/002

(57) ABSTRACT

Material transfer trailers including an elongate chassis, and a longitudinally extending conveyor for transferring material to a desired location, the conveyor being supported by the chassis and including a main portion mounted to the chassis, the main portion having a lower end and an upper end opposite the lower end, an extension portion including a link end moveably mounted to the upper end of the fixed portion and a discharge end opposite the link end, wherein the extension portion is configured to move between an extended position and a stowed position. In some examples, the main portion is fixedly mounted to the chassis. In some examples, the extension portion is pivotally mounted to the main portion. In some examples, the conveyor defines a void to receive a rear-mounted projection of a receiving vehicle.

### CROSS-REFERENCE TO RELATED APPLICATIONS

This application is a continuation of U.S. patent application Ser. No. 15/262,876, filed Sep. 12, 2016, which application is a continuation of U.S. patent application Ser. No. 13/355,896, filed Jan. 23, 2012, which application is a continuation of U.S. patent application Ser. No. 12/217,695, filed Jul. 8, 2008, the entireties of which are hereby incorporated herein by reference for all purposes.

### BACKGROUND

Trailers are commonly used to transfer material from one site to another, such as from a material depot to a job site. Often times, trailers are not self-propelled, but instead are towed by other vehicles to get from site to site. Compared to certain multi-purpose or specialty vehicles, such as material spreaders, dump trucks, or multi-mix cement trucks, trailers can provide relatively inexpensive and flexible mobile storage capacity.

For example, material spreaders are vehicles designed to spread a variety of aggregate materials, including rock, sand, or mulch, over a desired area. Material spreaders typically include onboard means to store a limited amount of material, but may not have storage capacity to store enough material for larger jobs. Similarly, mini-mix concrete trucks are vehicles designed to store separated concrete components and mix them together at a job site to form concrete as needed. Mini-mix concrete trucks can deplete one or more individual components when supplying concrete at a job site. Replenishing the depleted component at the job site is advantageous because it avoids downtime due to the mini-mix concrete truck traveling back to a material depot.

While a trailer is useful for transferring material to a job site, it is also typically necessary to transfer the material from the trailer to a specific location. For example, it may be necessary to transfer material from the trailer to a vehicle or machine configured for a given application or to a given spot on the ground. Conveyors are often useful for transferring material from a trailer to a specific location, such as to a material spreader, a mini-mix concrete truck, or other vehicle configured for a given application.

As is known in the art, conveyors typically include an elongate frame set at an upward angle to move material from a lower position to an upper position. Conveyers often include a moving “continuous” belt that moves around the elongate frame. Material is placed onto the belt at a lower end of the frame and is carried to the upper end of the frame by the belt.

Conveyors can be cumbersome machines to incorporate into a trailer given their elongate proportions. For example, a conveyor may extend beyond the body of a trailer, making them difficult and potentially unsafe to transport on public streets. In fact, a given conveyor may exceed permissible length and/or height regulations for vehicles being driven or towed on state and local highways. Accordingly, there is an existing need for a trailer incorporating a conveyor that can be simply and expeditiously modified for safe transport on public roads.

Positioning known trailers at a job site is often inconvenient and requires preplanning to make transferring material from the trailer feasible. Job sites can have limited space available for a towing vehicle to position a trailer at a job site. Some known trailers include conveyors that extend from a side of the trailer opposite its hitch. As such, space sufficient for the towing vehicle, the trailer, and the vehicle receiving material opposite the towing vehicle is required. Thus, there exists a need for a trailer that allows for more efficient use of space at a job site.

Aligning a vehicle with a conveyor of a trailer to receive material from the trailer can be difficult. Vehicles that receive material from a trailer may have projections extending from them, such as spreading mechanisms, chutes, lifts, or booms. The projections can extend beyond a vehicle's material storage container. As such, the projections can often be in positions that interfere with a conveyor approaching the container to transfer material into it. Thus, there is a need for a trailer that can accommodate a vehicle's projections as it transfer material to the vehicle.

The following U.S. patents provide examples of trailers and/or conveyors and are expressly incorporated herein by reference for all purposes: U.S. Pat. Nos. 2,022,146, 2,834,487, 3,365,050, 4,058,198, 4,245,732, 4,981,204, 6,129,196, 6,302,265, and 6,705,449. While each of these examples has its own merit, the need remains for material transfer trailers and methods of transferring material that address the limitations existing with known trailers and methods.

### SUMMARY

Material transfer trailers including an elongate chassis, and a longitudinally extending conveyor for transferring material to a desired location, the conveyor being supported by the chassis and including a main portion mounted to the chassis, the main portion having a lower end and an upper end opposite the lower end, an extension portion including a link end moveably mounted to the upper end of the fixed portion and a discharge end opposite the link end, wherein the extension portion is configured to move between an extended position and a stowed position. In some examples, the main portion is fixedly mounted to the chassis. In some examples, the extension portion is pivotally mounted to the main portion. In some examples, the conveyor defines a void to receive a rear-mounted projection of a receiving vehicle.

### BRIEF DESCRIPTION OF THE DRAWINGS

FIG. 1 is a side view of a material transfer trailer hitched to a receiving vehicle and including an extension portion in a stowed position.

FIG. 2 is a side view of the material transfer trailer of FIG. 1, with the extension portion in an extended position.

FIG. 3 is a side view of the conveyor of the material transfer trailer of FIG. 1 extending over a projection of the receiving vehicle.

FIG. 4 is a side view of the material transfer trailer of FIG. 1 hitched to a receiving vehicle and with the extension portion in the stowed position.

FIG. 5 is a side view of the material transfer trailer of FIG. 1 fluidly coupled to a receiving vehicle and with the extension portion in the extended position.

FIG. 6 is a plan view of the material transfer trailer of FIG. 1 fluidly coupled to a receiving vehicle and with the extension portion in the extended position.

FIG. 7 is a schematic view of a method of transferring material to a receiving vehicle from a material transfer trailer.

FIG. 8 is a more detailed schematic view of the method of transferring material to a receiving vehicle from a material transfer trailer of FIG. 7.

### DETAILED DESCRIPTION

Trailers, systems, and methods for transferring material will become better understood through review of the following detailed description in conjunction with the drawings and the claims. The detailed description, drawings, and claims provide merely examples of the various inventions described herein. Those skilled in the art will understand that the disclosed examples may be varied, modified, and altered without departing from the scope of the inventions as defined in the claims, and all equivalents to which they are entitled. Many variations are contemplated for different applications and design considerations; however, for the sake of brevity, each and every contemplated variation is not individually described in the following detailed description.

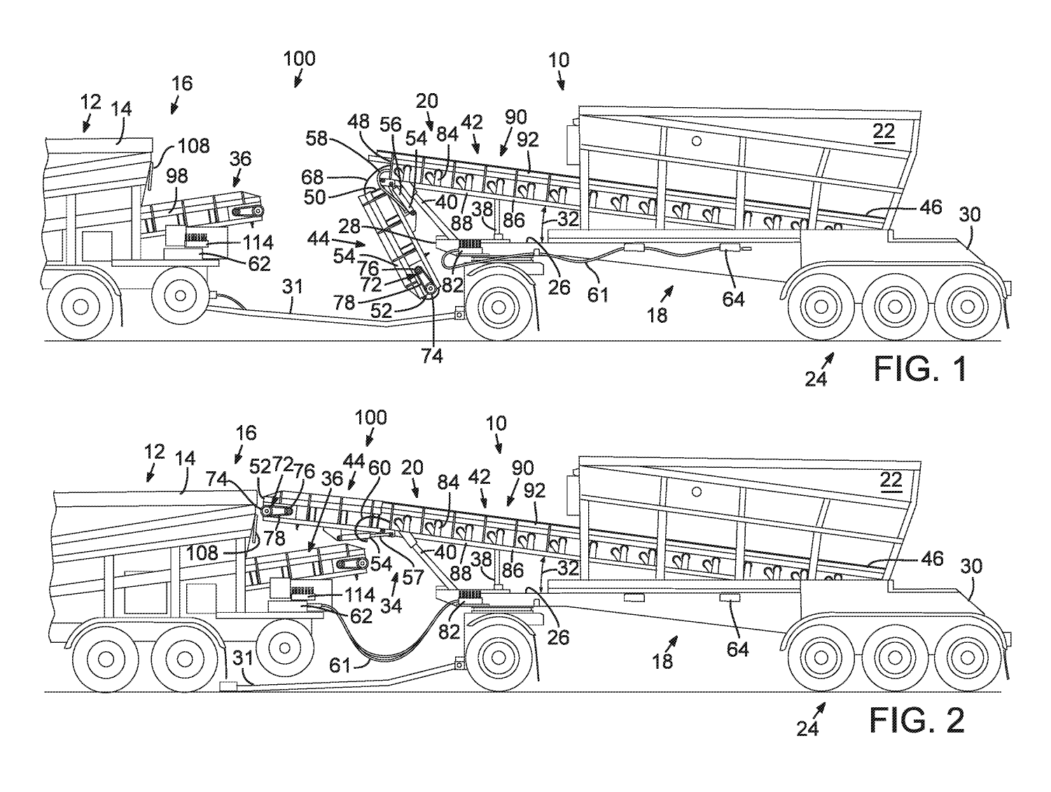

With reference to FIG. 1, a material transfer trailer 10 is shown that may be used to transfer material to a desired location 12. Transferring material includes storing material within trailer 10 and towing trailer 10 to a job site. Further, transferring material includes moving the material from within trailer 10 to desired location 12 outside trailer 10 at the job site.

Material transferred by trailer 10 may include a variety of aggregate materials. Common aggregate materials includes rock, gravel, soil, mulch, bark fragments, and sand. The material may include components used in the formation of concrete. Other specialty materials suitable for a given application, such as fertilizer, coal, and solid chemical formulations may also be transferred. Agricultural products, including corn kernels, soybeans, and the like may be transferred by trailer 10 as well.

A variety of locations to transfer material may be desired. For example, desired locations include a given spot on the ground at a job site. A given spot on the ground may be desired because it is accessible by workers on foot or using mechanized equipment, such as bobcats and tractors. Other desired locations include storage containers mounted on vehicles, such as a storage container 14 mounted on a receiving vehicle 16 as shown in FIGS. 1-6. Storage containers at facilities may also serve as desired locations.

As shown in FIGS. 1 and 2, trailer 10 includes a chassis 18 and a conveyor 20 supported on chassis 18. The example of trailer 10 shown in FIGS. 1 and 2 further includes a hopper 22 for storing material. Hopper 22 has an angled bottom, angled upward from the rear toward the front, and an opening running substantially along a length of the bottom (see FIG. 6). Wheel assemblies 24 are provided for supporting chassis 18 from the ground and allowing trailer 10 to be towed to a job site. In some examples, chassis 18, hopper 22, and wheel assemblies 24 form a standard issue transfer truck trailer which is modified to accommodate conveyor 20 and other features of material transfer trailer 10.

Chassis 18 shown in FIGS. 1 and 2 provides a substantially flat and rigid platform 26 to support conveyor 20 and other components of trailer 10. Chassis 18 defines an elongate perimeter having a front end 28 and a rear end 30 opposite front end 28. Front end 28 is configured to couple with receiving vehicle 16, such as via a hitch 31 attached to front end 28 as shown in FIG. 1. Accordingly, front end 28 becomes the leading edge of chassis 18 when trailer 10 is towed.

Chassis 18 shown in FIGS. 1-6 supports conveyor 20 at an inclined angle 32 corresponding to the angled bottom of hopper 22. For example, as shown in FIGS. 1 and 2, chassis 18 may support conveyor 20 at an incline angle 32 of 10-20° above horizontal. An incline angle 32 of 10-20° may be selected to define a space or void 34 underneath conveyor 20 sufficient to accommodate a projection 36 of receiving vehicle 16, such as shown in FIGS. 2, 3, and 5. An incline angle 32 of 10-20° may also be selected to balance requirements related to conveyor length, width, speed, and torque.

The parameters of conveyor length, width, speed, and torque each play a role in the overall design of trailer 10. Generally, lower incline angles require a longer conveyor length to raise material to a given height. Longer conveyors can present safety and maneuverability issues when transporting them on public roadways. The width of the conveyor affects the material transfer rate of the conveyor, with wider conveyors being able to transfer more material per unit length at a given conveyor speed.

The speed of the conveyor also affects material transfer rate, as well as the discharge momentum imparted to the material. Increased transfer rates, conveyor angles, and conveyor speeds all tend to increase the torque required for the conveyor to raise and discharge the material. An incline angle 32 of 10-20° has been found to provide a suitable balance of these parameters and make trailer 10 convenient to transport on public roadways.

To support conveyor 20 at an inclined angle 32, chassis 18 shown in FIGS. 1 and 2 includes platform 26, a first strut 38, and a second strut 40. First and second struts 38, 40 are rigidly connected to platform 26. First strut 38 extends vertically from platform 26 to conveyor 20. Second strut 40 extends from platform 26 to conveyor 20 at an angle to support a portion of conveyor 20 extending beyond the perimeter of platform 26. In some examples, a single strut is utilized to support conveyor 20.

First and second struts 38, 40 shown in FIGS. 1 and 2 are formed of a rigid material and they set a fixed incline angle 32, such as between 10 and 20°. A fixed incline angle may facilitate rapid operational readiness, enhanced structural rigidity, and increased reliability deriving from fewer moving parts. Further, as shown in FIGS. 2, 3, and 5, supporting conveyor 20 at a fixed incline angle 32 defines a fixed space or void 34 underneath conveyor 20 to accommodate projection 36 of receiving vehicle 16. Any rigid material sufficient to support conveyor 20 during transport and material transfer may be used to form first and second struts 38, 40.

In some examples (not pictured), the lengths of first and second struts 38, 40 are adjustable. Adjusting the lengths of struts 38, 40 facilitates adjusting incline angle 32 of conveyor 20. In examples where the length of struts 38, 40 is adjustable, struts 38, 40 may be formed of or include hydraulic cylinders, ratchet mechanisms, or jacking devices.

Conveyor 20 shown in FIGS. 1-6 includes a main portion 42 and an extension portion 44 pivotally mounted to main portion 42. Main portion 42 is fixed in an angled position, and accordingly, may be referred to as a fixed portion. Main portion 42 includes a lower end 46 proximate the rear end of hopper 22 and an upper end 48 proximate front end 28 of chassis 18. Extension portion 44 includes a link end 50 pivotally mounted to upper end 48 of main portion 42 and includes a discharge end 42 opposite link end 50. Material is discharged from conveyor 20 at discharge end 42.

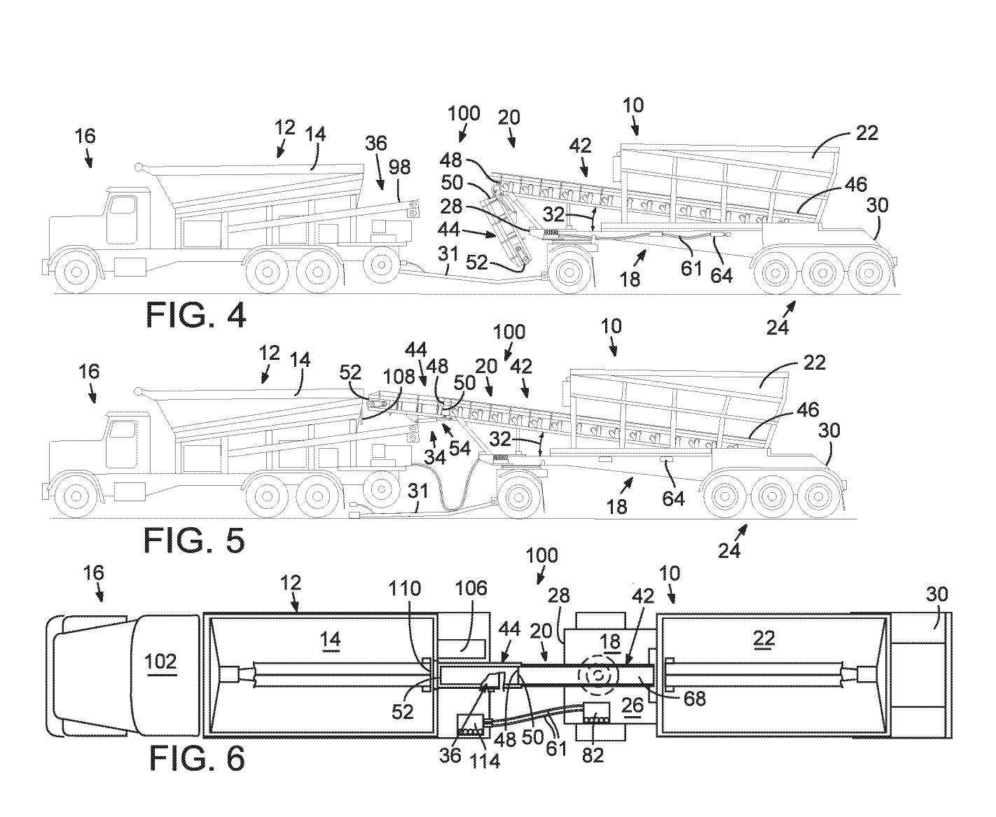

Extension portion 44 pivots between a stowed position (shown in FIGS. 1 and 4) and an extended position (shown in FIGS. 2 and 5). In the extended position, extension portion 44 extends inline from main portion 42 and discharge end 52 is distal chassis 18. The inline length of conveyor 20 increases when extension portion 44 is in the extended position. In the stowed position, extension portion 44 is proximate front end 28 of chassis 18 and the inline length of the conveyor decreases relative to when in the extended position. Accordingly, transporting trailer 10 on public roadways when conveyor 20 is in the stowed position may be more suitable, safe, and convenient than when in the extended position.

In other examples (not pictured), the extension portion is mounted to the main portion in a variety of ways to facilitate movement of the extension portion relative to the main portion. For example, the extension portion may be slidingly mounted to the main portion. When the extension portion is slidingly mounted to the main portion, the extension portion moves between the extended position and the stowed position by sliding relative to the main portion.

Conveyor 20 includes an actuator 54 for moving extension portion 44 between the stowed position and the extended position. In the example shown in FIGS. 1-6, actuator 54 includes a hydraulic cylinder 56 and an arm member 57. In other examples (not pictured), actuator 54 may include a motorized pulley or winch system and/or a pneumatic lifting device.

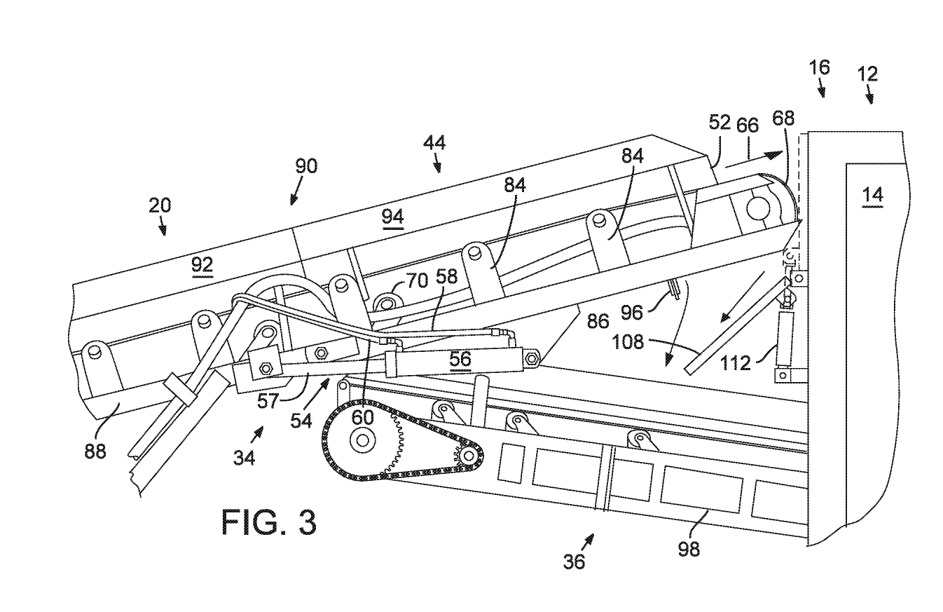

As shown in FIG. 3, hydraulic cylinder 56 is fed with pressurized hydraulic fluid, such as oils, via an inlet hose 58 to extend arm member 57. To retract arm member 57, the hydraulic fluid is removed from hydraulic cylinder 56 via an outlet hose 60. In the example shown in FIGS. 1-6, the pressurized hydraulic fluid is supplied from a reservoir (not pictured) and a pump (not pictured) on receiving vehicle 16 via transfer hoses 61 that fluidly couple with ports 62 on receiving vehicle 16. Chassis 18 includes mounts 64 to mount transfer hoses 61 when they are not fluidly coupled to receiving vehicle 16 via ports 62. All suitable valves and valve control mechanisms for hydraulic cylinders are provided. In some examples, the valves and valve control mechanisms are remotely and wirelessly controlled.

When extension portion 44 is in the extended position, conveyor 20 can transfer material from trailer 10 to desired location 12. As shown in FIG. 3, conveyor 20 transfers material by propelling or launching the material through the air to desired location 12; in this case, storage container 14 mounted to receiving vehicle 16. The material propelled through the air follows a trajectory 66 determined by a combination of incline angle 32, the speed of conveyor 20, and the slope of the ground on which trailer 10 rests.

Conveyor 20 shown in FIGS. 1-6 includes a belt 68 supported on rollers 70. Belt 68 rotates along rollers 70 when driven by a drive mechanism 72. Drive mechanism 72 may be powered by hydraulic, pneumatic, electrical, or fuel combustion means. In the example shown in FIGS. 1-6, drive mechanism 72 is powered via pressurized hydraulic fluid supplied by receiving vehicle 16. As shown in FIGS. 1, 2, 4, and 5, drive mechanism 72 includes a first sprocket 74 and a second sprocket 76 linked via a drive chain 78. Conveyor 20 may include a drive control mechanism (not pictured) for activating drive mechanism 72 and varying its speed. The drive control mechanism may be configured to respond to commands input by a user from a remote location, such as with a wireless input device. Additionally or alternatively, the drive control mechanism may be configured to respond to commands input by a user into a trailer control box 82 mounted to trailer 10.

Belt 68 shown in FIGS. 1-6 extends continuously around both main portion 42 and extension portion 44 of conveyor 20 when extension portion 44 is in the extended position and when in the stowed position. As such, belt 68 may be referred to as a “continuous belt.” Belt 68 does not require tightening to operate effectively when extension portion 44 is moved into the extended position. Similarly, belt 68 does not need to be loosened prior to extension portion 44 being moved into the stowed position. Not needing to tighten or loosen belt 68 when moving extension portion 44 greatly increases the speed, efficiency, and convenience of moving extension portion 44 into different positions.

Rollers 70 are supported on brackets 84 mounted to a frame 86. Frame 86 includes longitudinally extending girders 88. As shown in FIG. 6, girders 88 may be wider than the width of projection 36 of receiving vehicle 16 so that conveyor 20 can accommodate projection 36 while transferring material to receiving vehicle 16. Brackets 84 cant rollers 70 inward to form a slight, longitudinally extending depression in belt 84. The depression helps seat the material on belt 84 to inhibit material sliding off of belt 84. Transferring material with a minimum of spillage is often an important requirement at a job site.

To further the ability of conveyor 20 to transfer material cleanly and efficiently, conveyor 20 includes a skirt 90 extending longitudinally along opposite longitudinal edges of belt 84. Skirt 90 forms a barrier along the longitudinal edges of belt 84 to inhibit material from moving off the sides of belt 84 and littering the job site. Skirt 90 includes a first skirt 92 extending along main portion 42 of conveyor 20 and a second skirt 94 extending along extension portion 44. First skirt 92 is configured to nest within second skirt 94 when extension portion 44 is in the extended position by being slightly narrower than second skirt 94 and overlapping slightly with second skirt 94.

To further promote clean material transfer, conveyor 20 includes a wiper 96 as shown in FIG. 3. Wiper 96 dislodges material stuck or partially stuck to belt 68. Stuck material adds weight to belt 68 and requires that belt 68 be cleaned more often. Further, the material can separate from belt 68 over time and create a mess by falling to the ground.

Wiper 96 may be positioned to deflect material towards receiving vehicle 16. In the example shown in FIGS. 1-6, wiper 96 is positioned to deflect material onto a supply conveyor 98 of receiving vehicle 16. In this position, wiper 96 deflects material, which was not transferred to storage container 14 of receiving vehicle 16 because it was stuck to belt 68, to an alternative location on receiving vehicle 16 that can accept the material.

A variety of different types of receiving vehicles may be supplied with material from trailer 10. In FIGS. 1-6, receiving vehicle 16 is a material spreader configured to spread material at a job site. Alternative receiving vehicles include dump trucks, pickup trucks, material screening vehicles, and mini-mix concrete trucks. Receiving vehicle 16 may be configured to tow trailer 10, such as via hitch 31. Material transfer trailer 10 combined with receiving vehicle 16 may be referred to as a material transfer system 100.

The material spreader receiving vehicle 16 shown in FIGS. 1-6 includes a truck body 102 supporting storage container 14, supply conveyor 98, and a spreader conveyor 106 for spreading material. Supply conveyor 98 is positioned to receive material from storage container 14 and transfer it to spreader conveyor 106.

Receiving vehicle 16 also includes a hydraulic fluid storage tank (not pictured) and a pump (not pictured) for pressurizing the hydraulic fluid. The pressurized hydraulic fluid from receiving vehicle 16 may be supplied to trailer 10 to power hydraulic cylinder 56 and/or drive mechanism 72.

With reference to FIG. 3, storage container 14 of receiving vehicle 16 includes a pivotally mounted gate 108. Gate 108 pivots between a closed position (shown in dashed lines in FIG. 3) and an open position (shown in solid lines in FIG. 3). In the closed position, gate 108 uncovers an opening 110 in storage container 14. Opening 110 is positioned in trajectory 66 of material discharged from conveyor 20, thus, providing a path for material to enter storage container 14. In the closed position, gate 108 covers opening 110.

As shown in FIG. 3, receiving vehicle 16 includes a gate pivoting mechanism 112 to pivot gate 108 between the open and closed positions. Gate pivoting mechanism 112 shown in FIG. 3 includes a hydraulic cylinder, but other gate pivoting mechanisms may include pneumatic, electrical, or fuel powered devices. Gate pivoting mechanism 112 may be activated from a remote position using a wireless input device or may be activated by inputting a command to a vehicle control box 114 mounted to receiving vehicle 16.

As shown in FIGS. 1-6, receiving vehicle 16 may include projection 36 extending beyond storage container 14. Projections can present obstacles to transferring material because they can be in a position that interferes with equipment, such as conveyors, of trailers attempting to transfer material to the storage container. Projection 36 of material spreader receiving vehicle 16 shown in FIGS. 1-6 includes supply conveyor 98 and spreader conveyor 106.

In examples where the receiving vehicle is a mini-mix concrete truck, the receiving vehicle may include a projection in the form of a concrete delivery chute. Concrete delivery chutes typically extend from the rear of mini-mix concrete trucks and can be pivoted between approximately −45° and 45° of a longitudinal midline of the truck. Orienting the concrete delivery chute to −45° and reversing the mini-mix concrete truck toward trailer 10 such that conveyor 20 approaches the truck from +45°, and vice versa, has proven an effective way to transfer material to concrete mini-mix concrete trucks.

When the receiving vehicle is a mini-mix concrete truck (or in other applications as well), hopper 22 of trailer 10 may include transversely extending dividers. The transverse dividers allow hopper 22 to keep separate and separately transfer different stored materials, such as different components of a concrete mixture. For example, with the dividers in place, trailer 10 can store sand in one portion of hopper 22 and rock in another portion.

Receiving vehicle 16 may optionally include a propulsion control mechanism (not pictured) allowing a user to drive and steer receiving vehicle 16 from a remote position, such as from a position adjacent trailer 10. In some examples, the propulsion control mechanism is configured to wirelessly receive control inputs from a wireless input device. Additionally or alternatively, a wired input device may be provided. The propulsion control mechanism may be operatively connected to one or more of a throttle, a transmission, and a steering assembly of receiving vehicle 16. As such, the propulsion control mechanism can reverse and steer the receiving vehicle in response to commands input by a user.

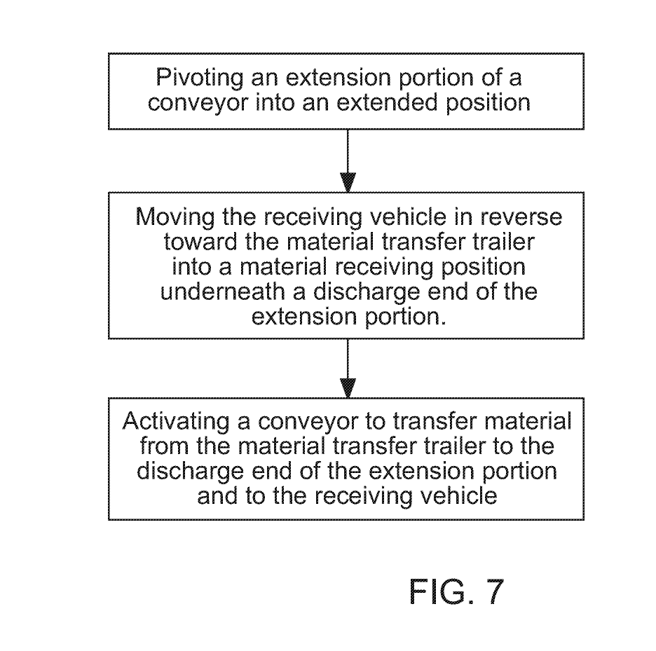

Turning attention to FIG. 7, a method of transferring material 200 will be discussed. Method 200 includes pivoting an extension portion of a conveyor into an extended position 202. Further, method 200 includes moving the receiving vehicle in reverse toward the material transfer trailer into a material receiving position adjacent a discharge end of the extension portion of the conveyor 204. Moreover, method 200 entails activating the conveyor to transfer material from the material transfer trailer to the receiving vehicle 206.

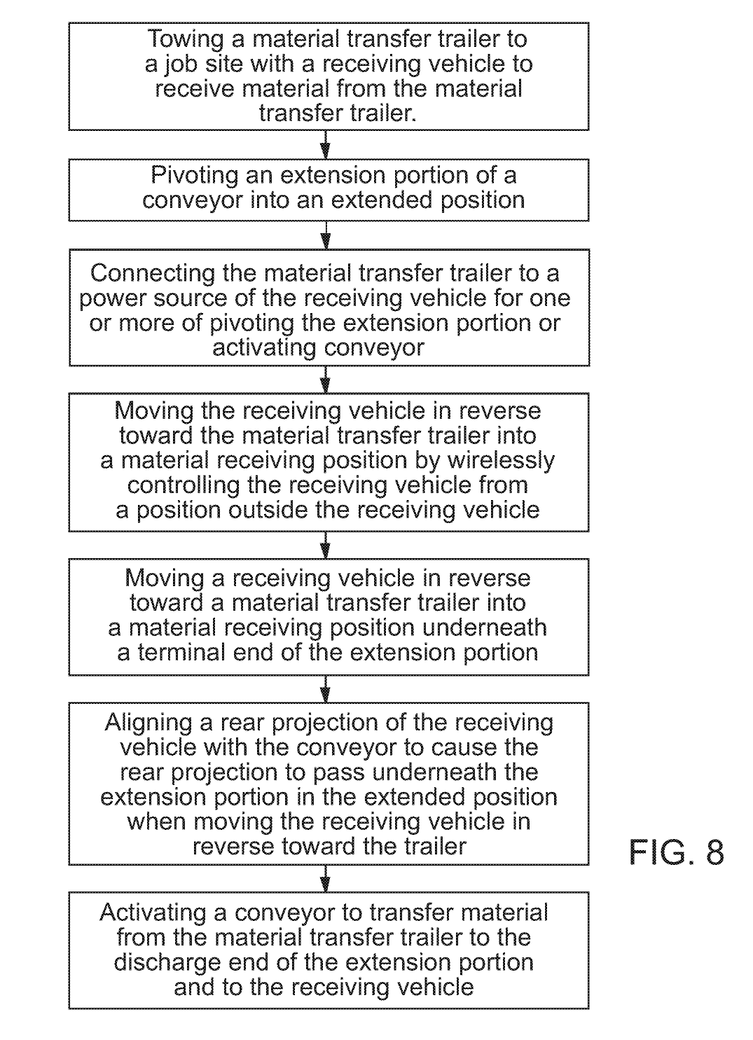

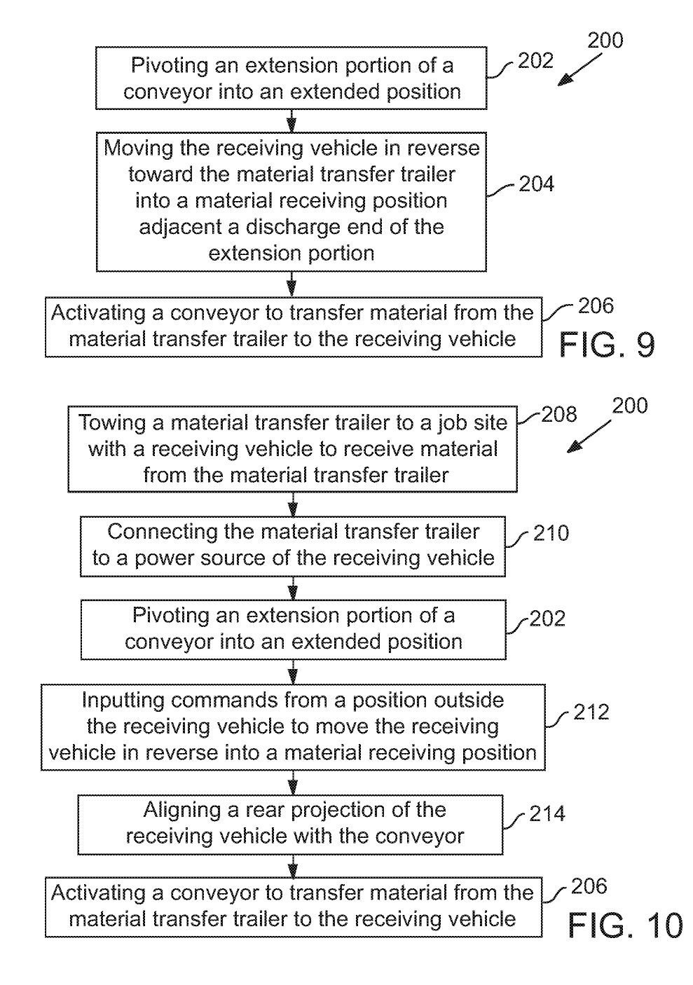

With reference to FIG. 8, an example of method 200 including additional optional steps is shown. As shown in FIG. 8, method 200 may include towing a material transfer trailer to a job site with a receiving vehicle 208. Of course, the trailer need not be towed by the receiving vehicle and can instead be towed by any vehicle capable of towing a trailer. However, using the receiving vehicle to tow the trailer provides an efficient and convenient means to get the trailer to the same location as the receiving vehicle.

As shown in FIG. 8, method 200 may include connecting the trailer to a power source of the receiving vehicle 210. Connecting the trailer to a power source of the receiving vehicle can facilitate operating components of the trailer without requiring an independent power supply or “pony engine” for the trailer. For example, the power supply of the receiving vehicle can be used to pivot the extension portion of the conveyor or to activate the conveyor. Thus, the trailer weight, cost, and complexity can be decreased when utilizing a power source of the receiving vehicle. Additionally or alternatively, connecting to the power supply of the receiving vehicle may provide supplemental power for use in conjunction with an independent power supply of the trailer.

The trailer can connect to a variety of power supplies. For example, the power supply may be a hydraulic fluid reservoir and pump supplying pressurized hydraulic fluid. Connecting to the supply of pressurized hydraulic fluid may be accomplished by connecting hoses to fluid ports on the receiving vehicle. Additionally or alternatively, the power supply may include an electrical generator or battery. Connecting to the electricity source may include plugging a power cord into an electrical socket electrically connected to the generator or battery. In some examples, the power supply is an air compressor supplying pressurized air. Connecting to the air compressor is accomplished using pneumatic tubing.

Pivoting the extension portion of the conveyor into an extended position 202 may enable the conveyor to transfer material to the receiving vehicle. The extension portion may be pivoted upward from a position below the conveyor into the extended position. Alternatively, the extension portion may be pivoted downward from a position above the conveyor. In some examples, the conveyor is initially positioned to either side of the conveyor and pivoted sideways into the extended position.

As shown in FIG. 8, method 200 may include inputting commands from a position outside the receiving vehicle to move the receiving vehicle in reverse into a material receiving position 212. For example, the commands may be entered into a wireless or wired input device. The material receiving position may be adjacent the discharge end of the conveyor. Utilizing a wireless controller to move the receiving vehicle can allow a user to be positioned near the trailer in a good vantage point to direct the receiving vehicle into the receiving position. For example, a user positioned near the trailer may be better able to align a projection of the receiving vehicle with the conveyor of the trailer.

Regardless of the user's position, the method may include aligning a rear projection of the receiving vehicle with the conveyor 214. Aligning the rear projection with the conveyor 214 may cause the rear projection to move into a position underneath the conveyor, such as underneath the extension portion when the extension portion is in the extended position. In some examples, the rear projection is moved into a position directly underneath the conveyor and substantially inline with the conveyor.

With further reference to FIG. 8, the method includes activating the conveyor to transfer material from the material transfer trailer to the receiving vehicle 206. Activating the conveyor 206 may involve turning on a drive mechanism configured to rotate a belt of the conveyor. Rotating the belt at an appropriate speed may launch or propel material from the conveyor, such as from a discharge end of the conveyor. Launching or propelling material from the discharge end of the conveyor may thus effectuate transfer of material from the trailer to the receiving vehicle.

It is believed that the disclosure set forth above encompasses multiple distinct inventions with independent utility. While each of these inventions has been disclosed in a particular form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein, and equivalents of them. Where the disclosure or subsequently filed claims recite “a” or “a first” element or the equivalent thereof, it is within the scope of the present inventions that such disclosure or claims may be understood to include incorporation of one or more such elements, neither requiring nor excluding two or more such elements.

Applicant reserves the right to submit claims directed to certain combinations and subcombinations that are directed to one of the disclosed inventions and are believed to be novel and non-obvious. Inventions embodied in other combinations and subcombinations of features, functions, elements and/or properties may be claimed through amendment of those claims or presentation of new claims in that or a related application. Such amended or new claims, whether they are directed to a different invention or directed to the same invention, whether different, broader, narrower or equal in scope to the original claims, are also regarded as included within the subject matter of the inventions of the present disclosure.

What is claimed is:

1. A method of transferring material to a receiving vehicle from a material transfer trailer, the method comprising:
storing material in a hopper of a material transfer trailer, the material transfer trailer including an elongate chassis having a front end configured to selectively couple with a towing vehicle, the hopper being mounted to the chassis and having an angled bottom and an opening running substantially along a length of the angled bottom, and a longitudinally extending conveyor including a main portion and an extension portion, the conveyor mounted to the chassis at an angle corresponding to the angled bottom of the hopper in a position to receive the material from the hopper through the opening, the main portion of the conveyor fixedly mounted to the chassis at the angle corresponding to the angled bottom of the hopper, the main portion having a lower end and an upper end, the lower end being proximate a rear end of the hopper, and the upper end being proximate the front end of the chassis, the extension portion of the conveyor including a link end pivotally mounted at only a single pivot connection to the upper end of the main portion, the extension portion further including a discharge end opposite the link end, and a single continuous conveyor belt passing around only the main portion and the extension portion of the conveyor;
disposing a receiving vehicle in a receiving position adjacent the front end of the chassis of the material transfer trailer, the receiving vehicle including a storage container;
moving the extension portion of the conveyor of the material transfer trailer into an extended position, such that the conveyor is extended above a rear-mounted projection of the adjacent receiving vehicle;
transferring the material from the hopper of the material transfer trailer to the storage container of the receiving vehicle using the conveyor of the material transfer trailer.

2. The method of claim 1, further including moving the extension of the conveyor into a stowed position by pivoting the extension portion at the single pivot connection, such that the conveyor is configured to allow unobstructed turning between the trailer and the towing vehicle during transport of the trailer on public roadways.

3. The method of claim 1, further comprising connecting the material transfer trailer to a power source of the receiving vehicle, such that the conveyor of the material transfer trailer is powered by the power source of the receiving vehicle.

4. The method of claim 1, wherein disposing the receiving vehicle in the receiving position includes inputting commands into a wireless controller from a position outside the receiving vehicle.

5. The method of claim 1, wherein disposing the receiving vehicle in the receiving position includes aligning the rear projection of the receiving vehicle with the conveyor to cause the rear projection to move into a position under the extension portion of the conveyor.

6. The method of claim 1, wherein transferring material from the material transfer trailer to the receiving vehicle includes modifying the speed of the conveyor to launch material to different locations of the storage container of the receiving vehicle.
